(19) United States
(12) Patent Application Publication
(10) Pub. No.: US 2017/0164007 A1
(43) Pub. Date: Jun. 8, 2017

(54) MIXED BOOLEAN-TOKEN ANS COEFFICIENT CODING

(71) Applicant: GOOGLE INC., Mountain View, CA (US)

(72) Inventor: Alexander Jay Converse, Oakland, CA (US)

(21) Appl. No.: 15/370,840

(22) Filed: Dec. 6, 2016

Related U.S. Application Data
(60) Provisional application No. 62/264,135, filed on Dec. 7, 2015.

(51) Int. Cl. H04N 19/645; H04N 19/124; H04N 19/44; H04N 19/13

(52) U.S. Cl. CPC H04N 19/645; H04N 19/13; H04N 19/124; H04N 19/44

(57) ABSTRACT

Decoding encoded transform coefficients of a current block includes initializing a decoder state of a state machine having Boolean and symbol ANS decoders. The decoder state includes an ANS state and a buffer position within a buffer storing a variable string including the encoded transform coefficients. The transform coefficients are sequentially produced from the variable string using the state machine by processing a binary flag/bit using the Boolean ANS decoder and processing a token using the symbol ANS decoder. Each decoder performs state normalization when the ANS state is outside a valid state range, performs output computation to generate an output value for the binary flag/bit or token using the ANS state and a probability, and updates the ANS state using the output value and the probability as inputs. The decoder state evolution operations may be different. An encoder state machine having Boolean and symbol ANS encoders is also described.

### BACKGROUND

Digital video streams typically represent video using a sequence of frames or still images. Each frame can include a number of blocks, which in turn may contain information describing the value of color, brightness or other attributes for pixels. The amount of data in a typical video stream is large, and transmission and storage of video can use significant computing or communications resources. Various approaches have been proposed to reduce the amount of data in video streams, including compression and other encoding techniques. Entropy coding is one technique that can be used in compression.

### SUMMARY

This disclosure relates in general to encoding and decoding visual data, such as video stream data, including mixed Boolean-token asymmetrical numeral system (ANS) coefficient coding.

One method taught herein describes decoding an encoded bitstream using a computing device, the encoded bitstream including frames, and the frames having blocks of pixels. The method includes receiving the encoded bitstream including encoded transform coefficients of a current block, initializing a decoder state of an entropy decoder state machine, the entropy decoder state machine including a Boolean asymmetric numeral system (ANS) decoder and a symbol ANS decoder, and the decoder state including an ANS state and a buffer position within a buffer storing a variable string including the encoded transform coefficients, and sequentially producing transform coefficients of the current block from the variable string using the entropy decoder state machine until an end of block flag is reached or a maximum number of transform coefficients is output. Sequentially producing the transform coefficients occurs by processing a binary flag or bit using the Boolean ANS decoder to generate an output value for the binary flag or bit using the ANS state, and processing a token using the symbol ANS decoder to generate an output value for the token using the ANS state. The method also includes forming a transform block using the transform coefficients, inverse transforming the transform block to generate a residual block, and reconstructing the current block using the residual block.

An apparatus for decoding an encoded bitstream that includes frames having blocks of pixels includes an entropy decoder state machine including a Boolean asymmetric numeral system (ANS) decoder and a symbol ANS decoder sharing an ANS state and sharing a buffer position within a common buffer storing a variable string including encoded tokenized transform coefficients of a current block, the entropy decoder state machine performing a method comprising receiving the encoded bitstream including the encoded tokenized transform coefficients of the current block, decoding the encoded tokenized transform coefficients using the Boolean ANS decoder and the symbol ANS decoder, the Boolean ANS decoder decoding a token comprising a bit or a binary flag and the symbol ANS decoder decoding a token comprising a symbol operating according to a common state diagram comprising multiple nodes encompassing non-overlapping state ranges for the ANS state by performing a state normalization operation when the ANS state is outside a valid state range for the token by updating the ANS state by appending a bitstream data unit from the variable string, and updating the buffer position, performing an output computation operation to generate an output value for the token using the ANS state and a probability associated with the token, and performing a state evolution operation to update the ANS state using the output value and the probability as inputs, the state evolution operation of the Boolean ANS decoder being different from the state evolution operation of the symbol ANS decoder. The apparatus also includes a processor executing instructions stored in a non-transitory memory to form a transform block using decoded transform coefficients corresponding to the tokens, inverse transform the transform block to generate a residual block, and reconstruct the current block using the residual block.

An apparatus for encoding a video sequence including frames having blocks of pixels is also described. One such apparatus includes a processor configured to execute instructions stored in a non-transitory memory to form a transform block using transform coefficients of a current block, and tokenize the transform coefficients of the transform block. The apparatus also includes an entropy encoding state machine including a Boolean asymmetric numeral system (ANS) encoder and a symbol ANS encoder sharing an ANS state and sharing a buffer position within a common buffer storing a variable string including encoded tokenized transform coefficients of the current block, the entropy encoder state machine performing a method comprising encoding the tokenized transform coefficients using the Boolean ANS encoder and the symbol ANS encoder, the Boolean ANS encoder encoding a token comprising a bit or a binary flag and the symbol ANS encoder encoding a token comprising a symbol operating according to a common state diagram by performing a state normalization operation when the ANS state is outside a valid state range for the token by updating the ANS state by removing a bitstream data unit from the ANS state into the variable string, and updating the buffer position, performing an output computation operation to generate an output value for the token using the ANS state and a probability associated with the token, and performing a state evolution operation to update the ANS state using the output value and the probability as inputs, the state evolution operation of the Boolean ANS decoding being different from the state evolution operation of the symbol ANS decoder.

Variations in this and other aspects of this disclosure will be described in additional detail hereafter.

### BRIEF DESCRIPTION OF THE DRAWINGS

The description herein makes reference to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of a video compression system in according to an aspect of the teachings herein.

FIG. 5 is a block diagram of a video decompression system according to another aspect of the teachings herein.

FIG. 6 is a state diagram of an entropy decoding state machine forming the entropy decoding stage of FIG. 5 according to an aspect of the teachings herein.

FIGS. 7A-7E are diagrams of entropy coding of a block of transform coefficients used to explain the state diagram of FIG. 6.

FIG. 8 is a state diagram of an entropy encoding state machine forming the entropy encoding stage of FIG. 4 according to an aspect of the teachings herein.

FIG. 9 is a block diagram of the entropy decoding state machine operating according to the state diagram of FIG. 6.

FIG. 10 is a block diagram of the entropy encoding state machine operating according to the state diagram of FIG. 8.

### DETAILED DESCRIPTION

A video stream may be compressed by a variety of techniques to reduce bandwidth required transmit or store the video stream. A video stream can be encoded into a bitstream, which can involve compression, and then transmitted to a decoder that can decode or decompress the video stream to prepare it for viewing or further processing. Encoding a video stream can involve parameters that make trade-offs between video quality and bitstream size, where increasing the perceived quality of a decoded video stream can increase the number of bits required to transmit or store the bitstream.

One technique to achieve superior compression performance exploits spatial and temporal correlation of video signals through spatial and/or motion compensated prediction. Transform coding subsequent to prediction is another technique that improves video compression. Generally, transform coding aims to largely remove the statistical redundancy between residual pixels after prediction by transforming them from the spatial domain to, e.g., the frequency domain. Entropy coding is a lossless coding technique that further reduces the amount of data needed within a bitstream to represent the transform coefficients. Entropy coding generally substitutes tokens for bit patterns in a datastream depending upon the relative frequency of the bit patterns. More common bit patterns are replaced with tokens that include fewer bits than the original bit pattern, thereby reducing the number of bits required to store or transmit for a given stream of digital data. Entropy coding can be implemented by analyzing the statistical properties of a video bitstream, for example, to determine the relative frequencies of bit patterns in the data. Entropy coding can use a plurality probability models based on the statistics of the video data to code the data. The transform coefficients may be quantized or not quantized before entropy coding.

Entropy coding involves trade-offs between processing speed and flexibility for the tokens (and relatedly, compression efficiency). Reading and writing whole tokens at a time is fast, but each technique for doing so has downsides. For example, Huffman coding of whole tokens uses coarse-grained probability distributions that can result in image degradation over fine probability granularity. Token encoding using pure range coders lacks flexibility. Tokens may also be written as Boolean trees. While this technique is highly flexible, it is slow due to the need to read one Boolean decision at a time. Entropy coding using Context-adaptive binary arithmetic coding (CABAC) is very slow.

In contrast, the teachings herein describe using a single coder state and datastream for both Booleans and tokens within an entropy coding automaton. Mixing Booleans with token allows for higher flexibility than a pure token approach. In addition, the teachings herein provide fast encoding and decoding and high compression. Further details are described after an initial discussion of the environment in which the teachings herein may be used.

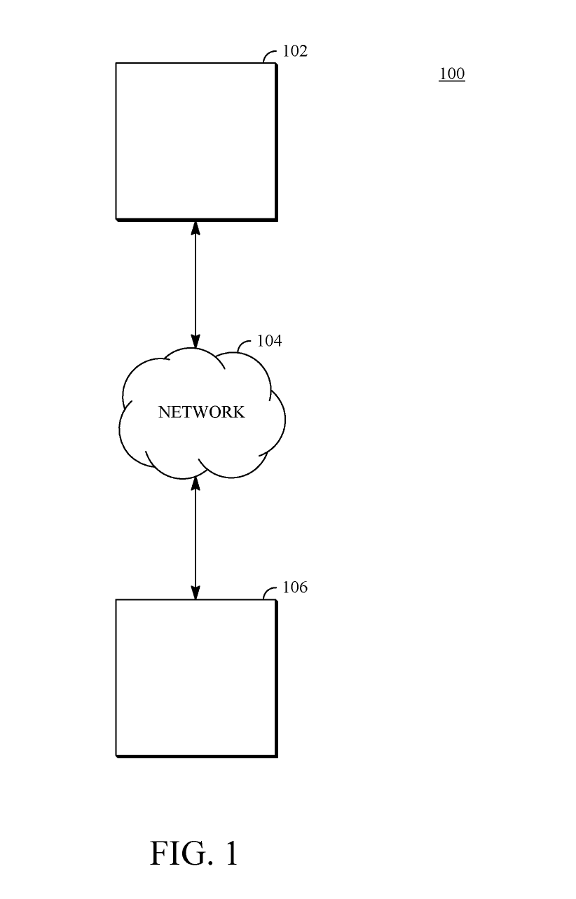

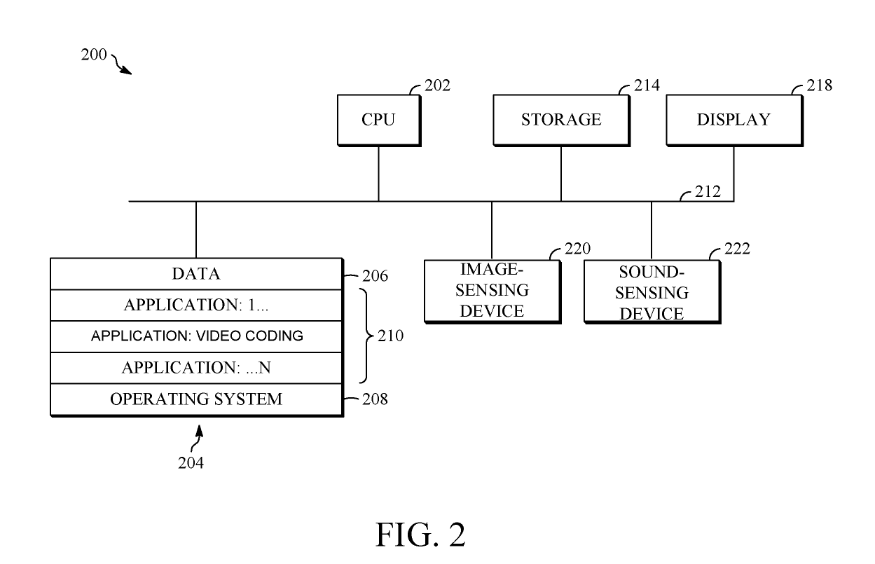

FIG. 1 is a schematic of a video encoding and decoding system 100. A transmitting station 102 can be, for example, a computer having an internal configuration of hardware such as that described in FIG. 2. However, other suitable implementations of transmitting station 102 are possible. For example, the processing of transmitting station 102 can be distributed among multiple devices.

A network 104 can connect transmitting station 102 and a receiving station 106 for encoding and decoding of the video stream. Specifically, the video stream can be encoded in transmitting station 102 and the encoded video stream can be decoded in receiving station 106. Network 104 can be, for example, the Internet. Network 104 can also be a local area network (LAN), wide area network (WAN), virtual private network (VPN), cellular telephone network or any other means of transferring the video stream from transmitting station 102 to, in this example, receiving station 106.

Receiving station 106, in one example, can be a computer having an internal configuration of hardware such as that described in FIG. 2. However, other suitable implementations of receiving station 106 are possible. For example, the processing of receiving station 106 can be distributed among multiple devices.

Other implementations of video encoding and decoding system 100 are possible. For example, an implementation can omit network 104. In another implementation, a video stream can be encoded and then stored for transmission at a later time to receiving station 106 or any other device having memory. In one implementation, receiving station 106 receives (e.g., via network 104, a computer bus, and/or some communication pathway) the encoded video stream and stores the video stream for later decoding. In an example implementation, a real-time transport protocol (RTP) is used for transmission of the encoded video over network 104. In another implementation, a transport protocol other than RTP may be used, e.g., a Hypertext-Transfer Protocol (HTTP)-based video streaming protocol.

When used in a video conferencing system, for example, transmitting station 102 and/or receiving station 106 may include the ability to both encode and decode a video stream as described below. For example, receiving station 106 could be a video conference participant who receives an encoded video bitstream from a video conference server (e.g., transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, computing device 200 can implement one or both of transmitting station 102 and receiving station 106 of FIG. 1. Computing device 200 can be in the form of a computing system including multiple computing devices, or in the form of a single computing device, for example, a mobile phone, a tablet computer, a laptop computer, a notebook computer, a desktop computer, and the like.

A CPU 202 in computing device 200 can be a central processing unit. Alternatively, CPU 202 can be any other type of device, or multiple devices, capable of manipulating or processing information now-existing or hereafter developed. Although the disclosed implementations can be practiced with a single processor as shown, e.g., CPU 202, advantages in speed and efficiency can be achieved using more than one processor.

A memory 204 in computing device 200 can be a read only memory (ROM) device or a random access memory (RAM) device in an implementation. Any other suitable type of non-transitory memory or storage device can be used as memory 204. Memory 204 can include code and data 206 that is accessed by CPU 202 using a bus 212. Memory 204 can further include an operating system 208 and application programs 210, the application programs 210 including at least one program that permits CPU 202 to perform the methods described here. For example, application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in secondary storage 214 and loaded into memory 204 as needed for processing.

Computing device 200 can also include one or more output devices, such as a display 218. Display 218 may be, in one example, a touch sensitive display that combines a display with a touch sensitive element that is operable to sense touch inputs. Display 218 can be coupled to CPU 202 via bus 212. Other output devices that permit a user to program or otherwise use computing device 200 can be provided in addition to or as an alternative to display 218. When the output device is or includes a display, the display can be implemented in various ways, including by a liquid crystal display (LCD), a cathode-ray tube (CRT) display or light emitting diode (LED) display, such as an organic LED (OLED) display.

Computing device 200 can also include or be in communication with an image-sensing device 220, for example a camera, or any other image-sensing device 220 now existing or hereafter developed that can sense an image such as the image of a user operating computing device 200. Image-sensing device 220 can be positioned such that it is directed toward the user operating computing device 200. In an example, the position and optical axis of image-sensing device 220 can be configured such that the field of vision includes an area that is directly adjacent to display 218 and from which display 218 is visible.

Computing device 200 can also include or be in communication with a sound-sensing device 222, for example a microphone, or any other sound-sensing device now existing or hereafter developed that can sense sounds near computing device 200. Sound-sensing device 222 can be positioned such that it is directed toward the user operating computing device 200 and can be configured to receive sounds, for example, speech or other utterances, made by the user while the user operates computing device 200.

Although FIG. 2 depicts CPU 202 and memory 204 of computing device 200 as being integrated into a single unit, other configurations can be utilized. The operations of CPU 202 can be distributed across multiple machines (each machine having one or more of processors) that can be coupled directly or across a local area or other network. Memory 204 can be distributed across multiple machines such as a network-based memory or memory in multiple machines performing the operations of computing device 200. Although depicted here as a single bus, bus 212 of computing device 200 can be composed of multiple buses. Further, secondary storage 214 can be directly coupled to the other components of computing device 200 or can be accessed via a network and can comprise a single integrated unit such as a memory card or multiple units such as multiple memory cards. Computing device 200 can thus be implemented in a wide variety of configurations.

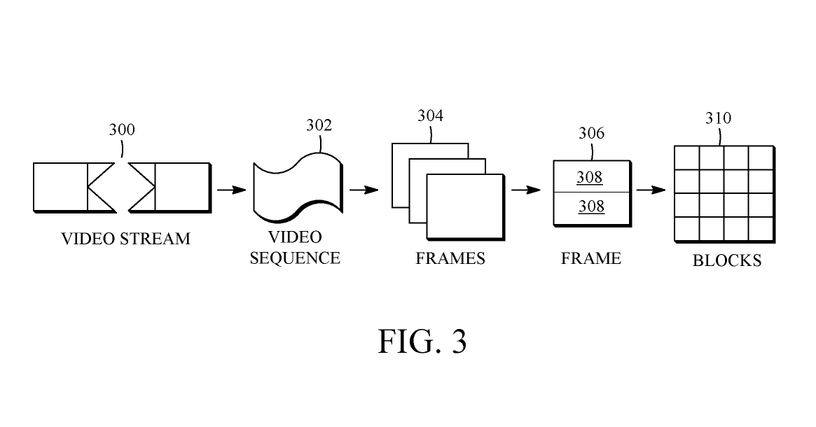

FIG. 3 is a diagram of an example of a video stream 300 to be encoded and subsequently decoded. Video stream 300 includes a video sequence 302. At the next level, video sequence 302 includes a number of adjacent frames 304. While three frames are depicted as adjacent frames 304, video sequence 302 can include any number of adjacent frames 304. Adjacent frames 304 can then be further subdivided into individual frames, e.g., a frame 306. At the next level, a frame 306 can be divided into a series of planes or segments 308. Segments (or planes) 308 can be subsets of frames that permit parallel processing, for example. Segments 308 can also be subsets of frames that can separate the video data into separate colors. For example, a frame 306 of color video data can include a luminance plane and two chrominance planes. Segments 308 may be sampled at different resolutions.

Whether or not frame 306 is divided into segments 308, frame 306 may be further subdivided into blocks 310, which can contain data corresponding to, for example, 16×16 pixels in frame 306 (e.g., blocks of pixels). Blocks 310 can also be arranged to include data from one or more planes of pixel data. Blocks 310 can also be of any other suitable size such as 4×4 pixels, 8×8 pixels, 16×8 pixels, 8×16 pixels, 16×16 pixels or larger.

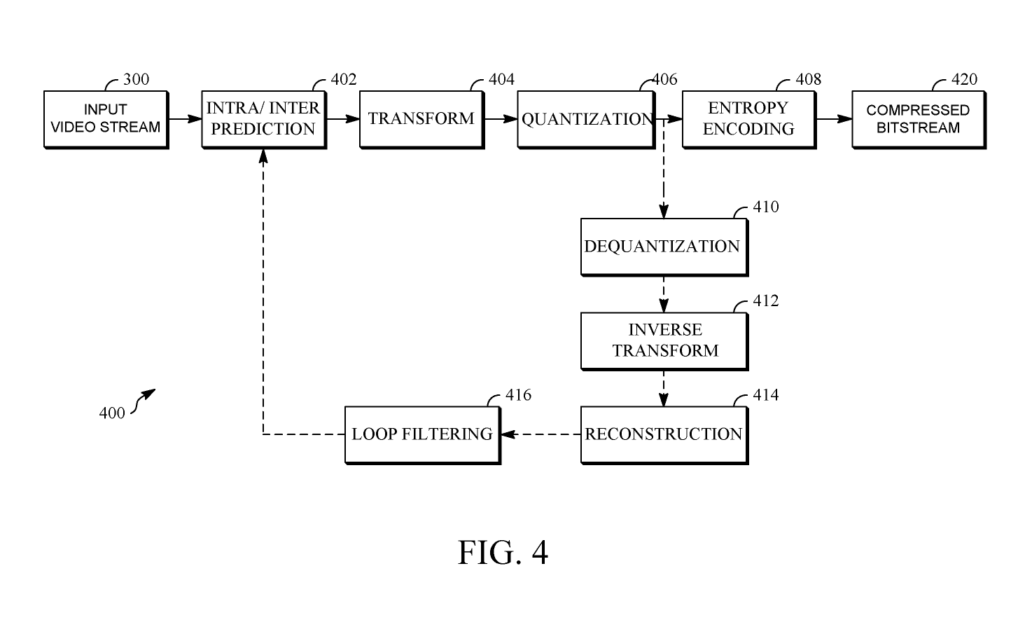

FIG. 4 is a block diagram of an encoder 400 in accordance with an implementation. Encoder 400 can be implemented, as described above, in transmitting station 102 such as by providing a computer software program stored in memory, for example, memory 204. The computer software program can include machine instructions that, when executed by a processor such as CPU 202, cause transmitting station 102 to encode video data in the manner described in FIG. 4. Encoder 400 can also be implemented as specialized hardware included in, for example, transmitting station 102. Encoder 400 has the following stages to perform the various functions in a forward path (shown by the solid connection lines) to produce an encoded or compressed bitstream 420 using video stream 300 as input: an intra/inter prediction stage 402, a transform stage 404, a quantization stage 406, and an entropy encoding stage 408. Encoder 400 may also include a reconstruction path (shown by the dotted connection lines) to reconstruct a frame for encoding of future blocks. In FIG. 4, encoder 400 has the following stages to perform the various functions in the reconstruction path: a dequantization stage 410, an inverse transform stage 412, a reconstruction stage 414, and a loop filtering stage 416. Other structural variations of encoder 400 can be used to encode video stream 300.

When video stream 300 is presented for encoding, each frame 306 can be processed in units of blocks. At intra/inter prediction stage 402, each block can be encoded using intra-frame prediction (also called intra prediction) or inter-frame prediction (also called inter prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at intra/inter prediction stage 402 to produce a residual block (also called a residual). Transform stage 404 transforms the residual into transform coefficients in, for example, the frequency domain using block-based transforms. Such block-based transforms include, for example, the Discrete Cosine Transform (DCT) and the Asymmetric Discrete Sine Transform (ADST). Other block-based transforms are possible. Further, combinations of different transforms may be applied to a single residual. In one example of application of a transform, the DCT transforms the residual block into the frequency domain where the transform coefficient values are based on spatial frequency. The lowest frequency (DC) coefficient at the top-left of the matrix and the highest frequency coefficient at the bottom-right of the matrix. It is worth noting that the size of a prediction block, and hence the resulting residual block, may be different from the size of the transform block. For example, the prediction block may be split into smaller blocks to which separate transforms are applied.

Quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by entropy encoding stage 408 according to the teachings herein as described in further detail below. The entropy-encoded coefficients, together with other information used to decode the block, which may include for example the type of prediction used, transform type, motion vectors and quantizer value, are then output to the compressed bitstream 420. Compressed bitstream 420 can also be referred to as an encoded video stream or encoded video bitstream, and the terms will be used interchangeably herein. A sequence of adjacent bits may be operated on as a unit by a computer. The number of adjacent bits forming the sequence can vary depending upon, e.g., the hardware of the computer. The unit is often referred to as a byte, and it conventionally comprises eight bits as eight bits is the smallest addressable unit of memory in many computer architectures. For this reason, the present disclosure discusses bytes in the examples. However, the teachings herein are not limited to a particular size for the unit as long as a uniform size (i.e., a same number of bits) is used, and the term bitstream data unit is used herein to refer to such a sequence of bits.

The reconstruction path in FIG. 4 (shown by the dotted connection lines) can be used to ensure that both encoder 400 and a decoder 500 (described below) use the same reference frames to decode compressed bitstream 420. The reconstruction path performs functions that are similar to functions that take place during the decoding process that are discussed in more detail below, including dequantizing the quantized transform coefficients at dequantization stage 410 and inverse transforming the dequantized transform coefficients at inverse transform stage 412 to produce a derivative residual block (also called a derivative residual). At reconstruction stage 414, the prediction block that was predicted at intra/inter prediction stage 402 can be added to the derivative residual to create a reconstructed block. Loop filtering stage 416 can be applied to the reconstructed block to reduce distortion such as blocking artifacts.

Other variations of encoder 400 can be used to encode compressed bitstream 420. For example, a non-transform based encoder 400 can quantize the residual signal directly without transform stage 404 for certain blocks or frames. In another implementation, an encoder 400 can have quantization stage 406 and dequantization stage 410 combined into a single stage.

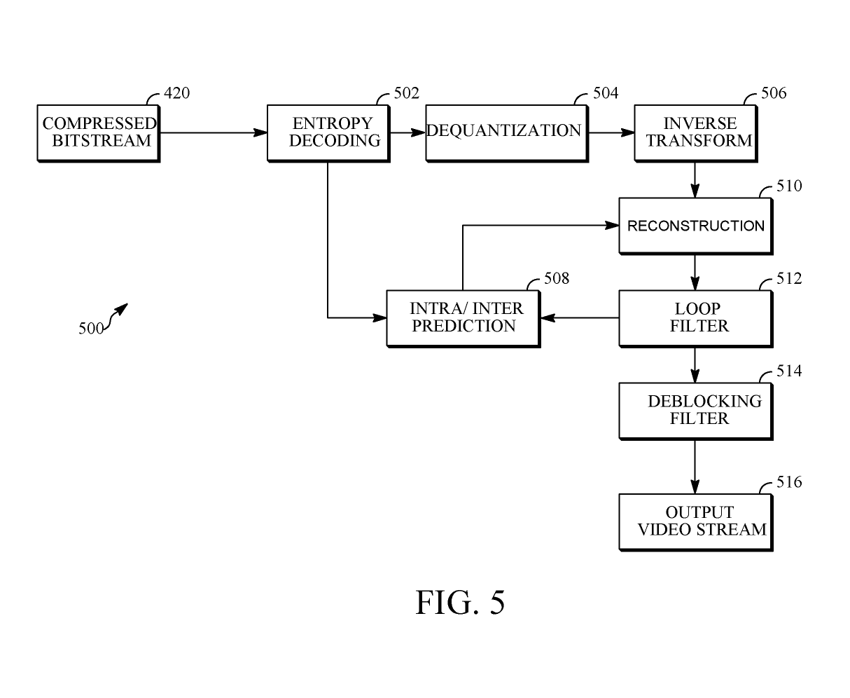

FIG. 5 is a block diagram of a decoder 500 in accordance with another implementation. Decoder 500 can be implemented in receiving station 106, for example, by providing a computer software program stored in memory 204. The computer software program can include machine instructions that, when executed by a processor such as CPU 202, cause receiving station 106 to decode video data in the manner described in FIG. 5. Decoder 500 can also be implemented in hardware included in, for example, transmitting station 102 or receiving station 106.

Decoder 500, similar to the reconstruction path of encoder 400 discussed above, includes in one example the following stages to perform various functions to produce an output video stream 516 from compressed bitstream 420: an entropy decoding stage 502, a dequantization stage 504, an inverse transform stage 506, an intra/inter prediction stage 508, a reconstruction stage 510, a loop filtering stage 512 and a deblocking filtering stage 514. Other structural variations of decoder 500 can be used to decode compressed bitstream 420.

When compressed bitstream 420 is presented for decoding, the data elements within compressed bitstream 420 can be decoded by entropy decoding stage 502 as discussed in additional detail herein to produce a set of quantized transform coefficients. Dequantization stage 504 dequantizes the quantized transform coefficients (e.g., by multiplying the quantized transform coefficients by the quantizer value), and inverse transform stage 506 inverse transforms the dequantized transform coefficients using the selected transform type to produce a derivative residual that can be identical to that created by inverse transform stage 412 in encoder 400. Using header information decoded from compressed bitstream 420, decoder 500 can use intra/inter prediction stage 508 to create the same prediction block as was created in encoder 400, e.g., at intra/inter prediction stage 402. At reconstruction stage 510, the prediction block can be added to the derivative residual to create a reconstructed block. Loop filtering stage 512 can be applied to the reconstructed block to reduce blocking artifacts. Other filtering can be applied to the reconstructed block. In this example, deblocking filtering stage 514 is applied to the reconstructed block to reduce blocking distortion, and the result is output as output video stream 516. Output video stream 516 can also be referred to as a decoded video stream, and the terms will be used interchangeably herein.

Other variations of decoder 500 can be used to decode compressed bitstream 420. For example, decoder 500 can produce output video stream 516 without deblocking filtering stage 514.

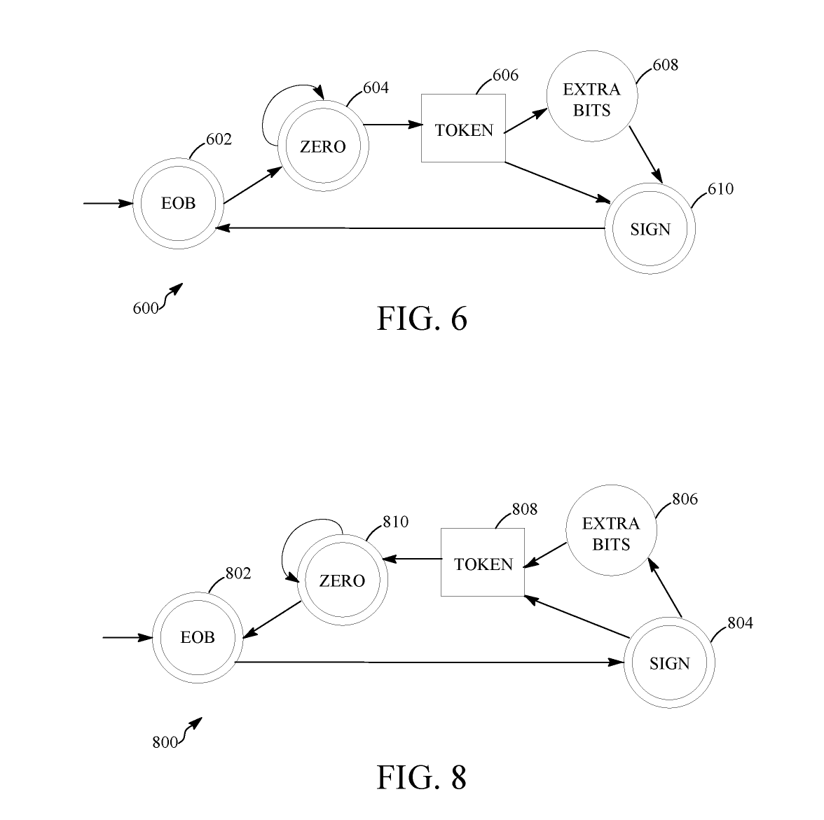

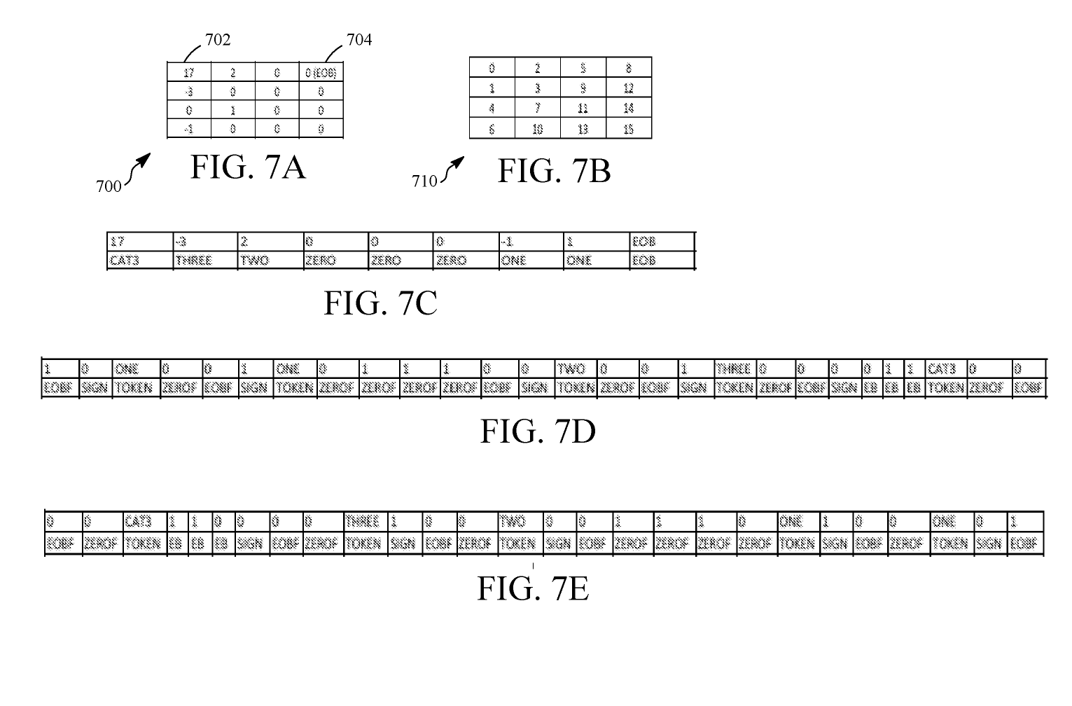

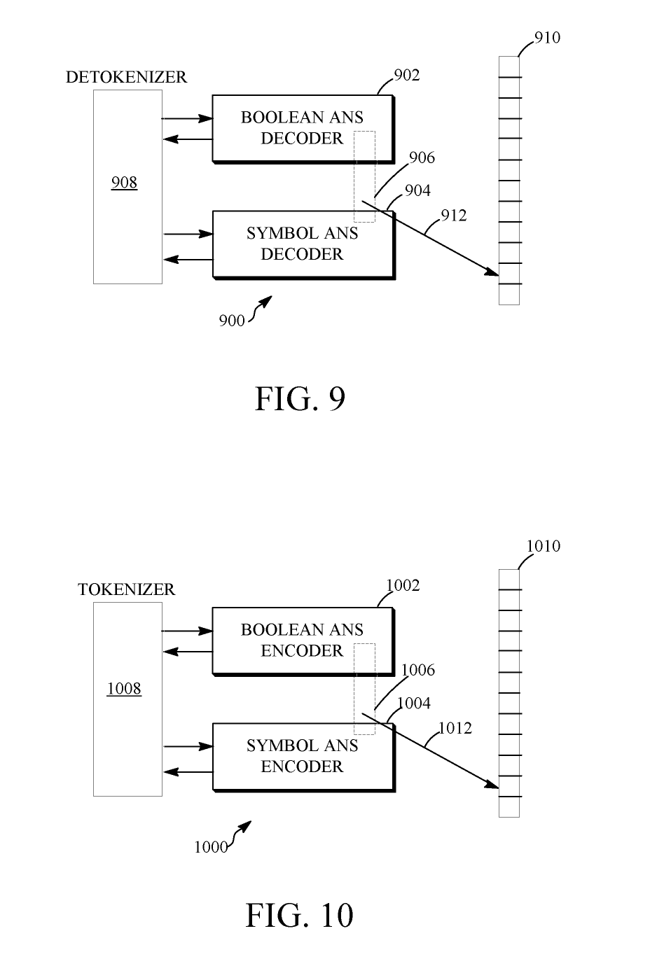

As mentioned briefly above, the teachings herein describe using a single coder state and datastream for both Booleans and tokens, which allows for high flexibility, fast coding and high compression. This can be achieved by an entropy coder automaton or state machine formed of a Boolean coder and a symbol (token) coder sharing a common single coder state and datastream. Details of one implementation of such an entropy coding state machine are described beginning with FIGS. 6 and 7A-7E. Because the examples described herein use a Boolean asymmetrical numeral system (ANS) coder and a symbol ANS coder as described in additional detail with respect to FIG. 9, the description of FIGS. 6 and 7A-7E may refer to ANS.

FIG. 6 is a state diagram 600 of an entropy decoding state machine forming the entropy decoding stage 502 of FIG. 5 according to an aspect of the teachings herein. Herein, the terms entropy coding, entropy coder, coding, or coder may be used when there is no need to distinguish between the entropy encoding and entropy decoding processes or machines. In the discussion herein, unless otherwise clear from context, the use of the term “read” means to output the value of a flag or token using the probability as discussed in more detail below, and the term “write” or “written” means to store the flag or token using the probability as discussed in more detail below.

FIGS. 7A-7E are diagrams of entropy coding of a block of transform coefficients used to explain the state diagram 600 of FIG. 6. FIG. 7A is a block 700 of transform coefficients. In this example, the block 700 is a 4×4 block of quantized transform coefficients having, for example, a DC coefficient 702 in the top-left corner of the block 700 (e.g., at position 0,0). The block 700 may be generated by applying a two-dimensional transform or separable one-dimensional transforms to a 4×4 block of residual values generated from inter prediction or intra prediction of a 4×4 (or larger block) of pixel data. Regardless of the technique used to generate the residual values and the resulting transform coefficients, they may be quantized using a quantizer value established at the frame, slice or block level. Alternatively, the transform coefficients may be entropy coded without quantization.

The coefficients of a block such as the block 700 are arranged in a scan order as a one-dimensional vector and are then processed in sequence. Various scan orders are possible including a raster order scan or a horizontal or vertical wavefront scan. One scan order is a zig-zag scan order that starts with the coefficient in the top-left corner and ends at the coefficient at the bottom-right corner. FIG. 7B is a block 710 that illustrates the scan order for the coefficients of the block 700. The scan order is the zig-zag scan order in this example. In the block 710, “0” represents the position of the first coefficient of the block 700 in the scan order. The coefficients are scanned in the sequence indicated until the last coefficient of the block 700 at position “15” as shown in the block 710 is reached. In order to reduce the number of transform coefficients to be coded into the bitstream, the final non-zero block is marked with an end-of-block (EOB) indicator or flag. In the block 700, for example, EOB 704 is located at position (0, 3), which corresponds to the ninth position in the scan order. This indicates that the last non-zero coefficient in the block 700 is at the eighth position in the scan order. By designating a position with the EOB flag, the encoder does not entropy encode the zero values, reducing bits within the bitstream, and the decoder, knowing the block size, uses zeroes as the value of any missing transform coefficient in the scan order to reconstruct the block once the entropy decoding state machine reaches the EOB flag.

The value of the EOB flag is shown in additional detail in FIG. 7C, which includes the tokenization of the transform coefficient values of the block 700 (including EOB 704) in the scan order shown in the block 710. The top row of FIG. 7C includes the values of the transform coefficients in the scan order. The bottom row of FIG. 7C includes the token associated with each transform coefficient based on those values. In this example, the available tokens are ZERO, ONE, TWO, THREE, FOUR, CATEGORY1 (CAT1), CATEGORY2 (CAT2), CATEGORY3 (CAT3), CATEGORY4 (CAT4), CATEGORY5 (CAT5), CATEGORY6 (CAT6), and EOB. Each token ZERO, ONE, TWO, THREE, AND FOUR represents a single value for the transform coefficient (i.e., 0, 1, 2, 3, and 4, respectively), and may be referred to herein as a single value token. Each of the category tokens represents a range of (e.g., quantized) values for the transform coefficients and is associated with a number of extra bits according to Table 1 below.

| | Quantized Values | |
|---|---|---|
| Category Token | Represented | Number of extra bits |
| CAT1 | 5-6 | 1 |
| CAT2 | 7-10 | 2 |
| CAT3 | 11-18 | 3 |
| CAT4 | 19-34 | 4 |
| CAT5 | 35-66 | 5 |
| CAT6 | 67-large | Transform dependent |

The value of “large” in CAT6 depends on the number of extra bits, which in turn is dependent on the transform used. The number of extra bits associated with a category token excludes the sign of the quantized value, which requires another bit as described below.

Each category token may be used to represent any value within the range shown depending upon the number assigned to the extra bit(s). For example, a category token represents the minimum value for the range, and a binary value associated with the extra bit(s) indicates the amount the coefficient value exceeds the minimum value. In FIG. 7C, for example, the category token CAT3 is assigned, and the three extra bits are assigned binary 110 to represent the DC coefficient 702 as discussed in more detail with respect to FIGS. 7D and 7E. Adding the minimum value of the token CAT3 of 11 to the number 6, which corresponds to binary 110, produces the coefficient value of 17.

Table 1 provides only one example of the use of category tokens to represent values for transform coefficients. The number of category tokens, their names, and the ranges of values represented by each category token, can vary based on any number of factors. For example, factors including the type of video data being encoded, whether or not the coefficients are quantized, what value or values are used for quantization, etc., may be used to provide alternative category tokens and ranges.

Returning again to FIG. 6, the single state diagram 600 of the entropy decoding state machine or automaton in this implementation includes multiple nodes, here five nodes or states, an EOB node 602, a ZERO node 604, a TOKEN node 606, an EXTRA BITS (EB) node 608, and a SIGN node 610. The EOB node 602, the ZERO node 604, and the SIGN node 610 include an additional border marking to indicate that they are “accepting states” (possible final states for a block). At the start of entropy decoding, a coefficient counter may be initialized. If an EOB is not reached before the maximum number of transform coefficients for a block has been decoded, the entropy coding for the block can end. This may occur, for example, where all transform coefficients of a block have non-zero values. The coefficient counter can be initialized for each transform block based on the number of transform coefficients of the transform block. In one example, the coefficient counter is initialized to the maximum number of transform coefficients that could be decoded (e.g., based on the block size such as 64 transform coefficients for a 8×8 block), and decremented (incremented by −1) upon completion of the entropy decoding of each transform coefficient so that entropy coding of the block ends when the coefficient counter reaches 0. In the alternative examples described herein, the coefficient counter increments by +1 from its initial count of 0 for comparison with the maximum number of transform coefficients for the block.

Referring again to FIG. 6, the initial state from a decode perspective is the EOB node 602. At the EOB node 602, the entropy decoding state machine, such as that described below with respect to FIG. 9, receives an encoded bitstream, and reads a binary ANS flag with an appropriate context probability. The binary ANS flag indicates whether or not the EOB has been reached for a current block so the flag read at the EOB node 602 may be more generically referred to herein as an EOB flag or EOBF. If the EOB has been reached (the flag value is “0”), detokenization is halted for the block. In contrast, on “1” the decoder state advances to the ZERO node 604.

As understood by those in the video coding arts, the appropriate context probability for a coding symbol (here the EOB) is a conditional probability of the value of the coding symbol (here whether the EOB exists, i.e., whether the value is 0 or 1). The context probability is provided by a context model that is based on the context of the coding symbol. The context can include, but is not limited to, the size of the block, the position being coded, previous values within the block already coded, the size of the transform used on the block, etc. Different symbols can use different context models and different context probabilities for coding. The same context probability is used to decode the symbol as was used to encode the symbol. Because the teachings herein do not require any particular technique for determining the appropriate context probability, additional explanation is omitted.

At the ZERO node 604, a zero flag or ZEROF is read. This flag may be another binary ANS flag read with an appropriate context probability. On a value of “0” for the binary ANS flag (e.g., representing that the token is ZERO), a zero value is outputted for the current transform coefficient (e.g., using a detokenizer). Then, the coefficient counter increments, and the state remains unchanged so that decoder remains at the ZERO node 604. On a value of “1” for the binary ANS flag, the state advances to the TOKEN node 606.

At the TOKEN node 606, a whole token is read at once, such as using ANS with an appropriate context probability as discussed in more detail with respect to FIG. 9. The token can take on a number of values or ranges of values. Using the category tokens in Table 1 as an example, the token can take on the values of ONE, TWO, THREE, FOUR, CAT1, CAT2, CAT3, CAT4, CAT5, or CAT6. If the value is a category token (as opposed to a single value token such as ONE, TWO, THREE, or FOUR), the state advances to the EXTRA BITS (or EB) node 608. Otherwise, the state advances directly to the SIGN node 610 after generating a numerical value (e.g., an integer) for the transform coefficient that corresponds to the single value token.

At the EB node 608, the number of additional bits that are needed to complete entropy decoding of the current transform coefficient is based on the category token. Each additional bit is independently decoded, such as using binary ANS with a fixed probability scheme. A (e.g., minimum) value of the category token and the extra bits generate a numerical value (e.g., an integer) for the transform coefficient.

Whether the token is a single value token or a category token, the state advances to the SIGN node 610 to read the sign of the transform coefficient using an appropriate context probability. For example, binary “0” may result in no sign (i.e., a positive value) for the transform coefficient, while binary “1” indicates that the transform coefficient is a negative number. The transform coefficient is outputted, and the coefficient counter increases. If the coefficient counter indicates that the maximum number of transform coefficients has been entropy decoded (e.g., the maximum numbered allowed for the block has been reached), then detokenization is halted. Otherwise, the decoder state returns to the EOB node 602.

In this example, entropy encoding and entropy decoding are implemented by respective state machines using ANS. FIG. 7D is an encoder ANS sequence for encoding the tokens of FIG. 7C using the values of Table 1. The decoder ANS sequence of FIG. 7E illustrates the application of the state diagram 600 to the resulting signal. The coefficient counter is initialized to 0, and the state is initialized to the EOB node 602. The maximum number of coefficients for the 4×4 block 700 is sixteen as seen in FIG. 7A.

With reference to FIG. 7E, the EOBF at the EOB node 602 is “0” so the state advances to the ZERO node 604. At this node, the ZEROF is “0”, which means that current transform coefficient is not zero. The state thus advances to the TOKEN node 60, where a token having a value of CAT3 is read. The token CAT3 is associated with a minimum transform value of 11 and three extra bits. At EB node 608, the additional three bits “1”, “1”, and “0” are each read with a fixed binary probability to obtain the additional value of 6. At the SIGN node 610, the bit “0” is read, resulting in a value of 17 being output for the first transform coefficient of the block. The coefficient counter is incremented. Because the coefficient counter is less than 16, the state returns to the EOB node 602.

Because the sequence of FIG. 7E shows that the EOBF is still read as “0”, the state moves from the EOB node 602 to the ZERO node 604. The ZEROF of “0” results in a state change to the TOKEN node 606, where the value for the token is read as THREE. This token is not a category token, so there are no additional bits. The state thus advances to the SIGN node 610, where the value for the sign is read as “1”. This indicates that the transform coefficient is negative, so the value −3 is output for the transform coefficient, the coefficient counter is incremented, and the state returns to the EOB node 602 because the coefficient counter (at a value of 2) is still less than 16.

At the EOB node 602, the value of the EOBF is again read using an appropriate context probability. The state moves from the EOB node 602 to the ZERO node 604 because the EOBF is read as “0” as seen in FIG. 7E. The ZEROF of “0” read at the ZERO node 604 results in a state change to the TOKEN node 606, where the value for the token is read as TWO. Like the token THREE, this token is not a category token. As there are no additional bits, the state advances to the SIGN node 610, where the value for the sign is read as “0”. This indicates that the transform coefficient is positive, so the value 2 is output for the transform coefficient, and the coefficient counter is incremented to 3. The coefficient counter being less than 16, the state returns to the EOB node 602.

The EOBF is read at “0” at the EOB node 602, indicating additional non-zero transform coefficients, so the state moves to the ZERO node 604. Unlike the previous situations, a ZEROF of “1” is read at the ZERO node 604. In this situation, zero is output as the value for the transform coefficient, and the coefficient counter is also incremented. The state remains at the ZERO node 604. There is no sign associated with the value zero, and the next transform coefficient can only be another zero or a non-zero value. Reading the next two bits of “1” in turn at the ZERO node 604 as shown in the sequence of FIG. 7E outputs the value zero for the next two transform coefficients and increments the coefficient counter to 6. The next EOBF read at the EOB node 602 is “0”, resulting in a change of state to the TOKEN node 606.

At the TOKEN node 606, a value of ONE is read for the token. This token is not a category token, so there are no additional bits. The state advances to the SIGN node 610, where the value for the sign is read as “1”—indicating a negative transform coefficient. The value −1 is output for the transform coefficient, the coefficient counter is incremented to 7, and the state returns to the EOB node 602 because the coefficient counter is still less than 16.

Still referring to FIG. 7E, the EOBF is read as “0” at the EOB node 602. As a result, the state advances once again to the ZERO node 604. The ZEROF of “0” read at the ZERO node 604 results in a state change to the TOKEN node 606, where the value for the token is read as ONE. Because there are no additional bits associated with this token value, the state advances to the SIGN node 610, where the value for the sign is read as “0”. This indicates that the transform coefficient is positive, so the value 1 is output for the transform coefficient, and the coefficient counter is incremented. The state returns to the EOB node 602 because the coefficient counter has a value of 8 (less than 16).

This time at the EOB node 602 the value “1” is read. This indicates the presence of the EOB flag and hence the end of non-zero coefficients of the block. Using the scan order to arrange the decoded transform coefficients, and filling in the remaining positions of the block with zeroes, results in the block 700 shown in FIG. 7A.

As can be seen by reviewing FIGS. 7C, 7D, and 7E, the block information is coded as a Last-In-First-Out stack. Tokens are encoded in reverse order from that described with respect to the state diagram 600 (that is, reverse bit order for extra bits, reverse state order for individual coefficients, and each coefficient in reverse order). This can be seen by reference to FIG. 8, which is a state diagram 800 of an entropy encoding state machine forming the entropy encoding stage 408 of FIG. 4 according to an aspect of the teachings herein. The entropy encoding state machine may be implemented by a Boolean ANS encoder and a symbol ANS encoder as discussed below in more detail with respect to FIG. 10.

As mentioned, tokens are entropy encoded in reverse order than they are later entropy decoded. The single state diagram 800 includes the same nodes—an EOB node 802, a SIGN node 804, an EXTRA BITS (EB) node 806, a TOKEN node 808, and a ZERO node 810. However, the state changes are different, and hence the encoder ANS sequence of FIG. 7D is the opposite of the decoder ANS sequence of FIG. 7E. For example, and using the state diagram 800, it can be seen that a value of “1” is written to the encoded bitstream (e.g., using a tokenizer) at the EOB node 802 with an appropriate context probability to reflect the presence of the EOB flag at the end of the tokenized coefficients of FIG. 7C before the state advances to encode the token ONE starting with the SIGN node 804. The value “0” is written for the sign using an appropriate context probability, and the state advances to the TOKEN node 808 without first advancing through the EB node 806 because the token ONE is not a category token. At the TOKEN node 808, the token ONE is written using an appropriate context probability. The state then advances to the ZERO node 810. Because the next token to be encoded is not the token ZERO, the state advances to the EOB node 802 after writing a “0” using an appropriate context probability. The next token is not EOB, so a “0” is encoded using an appropriate context probability. If there were no further tokens, encoding of the tokens for the current block would end. If there are further tokens, the state advances to the SIGN node 804 once again. The entropy encoding state machine operating according to the state diagram 800 may use a token counter in a like manner as the coefficient counter of the entropy decoding state machine operating according to the state diagram 600 with the maximum token counter value being determined by the maximum number of tokens to be encoded into the bitstream. In general, the transform block size, and hence the maximum number of tokens to be encoded, can be determined from the coding parameters such as the transform mode.

The ANS encoding sequence of FIG. 7D accordingly begins by with the EOBF value of “1” being encoded into the bitsteam and ends with the EOBF value of “0” being encoded into the bitstream—opposite to the decoding sequence of FIG. 7E. For this reason, further detailed description of the state changes associated with the state diagram 800 is omitted.

Referring to FIGS. 6 and 8, the TOKEN nodes 606, 808 are drawn as a different shape from the remaining nodes. This reflects the use of the token coefficient coding as compared to the Boolean coefficient coding. In this example, while the EOB nodes 602, 802, the ZERO nodes 604, 810, the EB nodes 608, 806, and the SIGN nodes 610, 804 are entropy coded using a Boolean ANS coder, the TOKEN nodes 606, 808 are entropy coded using a symbol ANS coder. The parallel operation of a Boolean ANS coder and a symbol (or token) ANS coder are discussed in additional detail with respect to FIGS. 9 and 10.

FIG. 9 is a block diagram of the entropy decoding state machine 900 operating according to the state diagram of FIG. 6. FIG. 10 is a block diagram of the entropy encoding state machine 1000 operating according to the state diagram 800 of FIG. 8. The state machines 900, 1000 may be implemented by asymmetrical numeral system (ANS) including a Boolean ANS coder (e.g., for flags/bits) and a symbol ANS coder (e.g., for tokens). More specifically, the entropy decoding state machine 900 includes a Boolean ANS decoder 902 and a symbol ANS decoder 904, and the entropy encoding state machine 1000 includes a Boolean ANS encoder 1002 and a symbol ANS encoder 1004.

Using ANS is desirable because both the tokens and the binary fields can be written and read into a single shared entropy coder state, backed by a single buffer. When referring to Boolean values, the term asymmetric binary systems (ABS) may be used instead of asymmetric numeral systems (ANS) because ABS is more specific to binary coding. However, this description uses ANS for consistency.

Operation of a Boolean ANS coder and a symbol ANS coder within either the entropy decoding state machine 900 or the entropy encoding state machine 1000 using a single state backed by a single buffer may be achieved by the selection of ANS parameters using certain constraints based on the size of the bitstream data unit (U), namely 2^{U}. The ANS input/output (I/O) base (b) is defined by (2^{U})ⁿ, where n is a small natural number (i.e., a positive integer). In some examples of the present disclosure, a probability granularity (m) is then selected that divides evenly into the I/O base, and an ANS base state (1) is selected that is divisible by (m). Due to this choice of parameters, all I/O may be done in whole units. For example, when the bitstream data unit is a byte (i.e., 8 bits), the ANS parameters may be based on 2⁸=256. In an example, the I/O base (b) is equal to 256 (implies n=1), the probability granularity (m) is equal to 256, and the ANS base state (1) is equal to 2¹⁰. This example results in streamable whole n-byte I/O and a maximum of one I/O event (read or write) per ANS Boolean or token.

Other values for the parameters may be used. For example, the probability granularity does not need to divide evenly into the I/O base. Further, an ANS base state between 2¹⁰ and 2¹⁸, inclusive, may be used when the bitstream data unit is a byte. The higher the ANS base state, the more likely that state normalization, described below, will involve more than one bitstream data unit. In an example where the ANS base state (1) is 2¹⁵, the I/O base is 2⁸, and the probability granularity is 2¹⁵, more than one bitstream data unit may be needed for state normalization. Higher ANS base states and higher values for the probability granularity allow more freedom to adjust probabilities dynamically in probability modelling (e.g., of the transform coefficients). In any event, the range of states is [ANS base state, I/O base*ANS base state]. Thus, the total number of states of the entropy decoding state machine 900 and the entropy encoding state machine 1000 is ANS base state*(I/O base−1).

The Boolean ANS decoder 902 and the symbol ANS decoder 904, and similarly the Boolean ANS encoder 1002 and the symbol ANS encoder 1004, have the same state range property. Accordingly, the decoders 902, 904 share a common decoder state (also called a current state) 906 including an ANS state (e.g., a scalar or integer) and a buffer position within a memory buffer 910. The memory buffer 910 stores the variable string representing the encoded tokens of the current block. Similarly, the encoders 1002, 1004 share a common encoder state 1006 including an ANS state (e.g., a scalar or integer) and a buffer position within a memory buffer 1010 that stores the variable string to which the encoded tokens of the current block are written before extraction to the encoded bitstream. In FIG. 9, one buffer position within the variable string is indicated with a pointer 912. In FIG. 10, one buffer position within the variable string is indicated with a pointer 1012. In the examples herein, the common ANS state of the decoders 902, 904 results in operation of the decoders 902, 904 according to one of the nodes of FIG. 6, and common ANS state of the encoders 1002, 1004 results in operation of the decoders 902, 904 according to one of the nodes of FIG. 8. That is, each of the nodes of FIGS. 6 and 8 encompasses a non-overlapping range of states (also referred to as non-overlapping state ranges) based on the selection of ANS parameters described above.

A state machine, stated most simply, is a digital device that traverses through a predetermined sequence of states in an orderly fashion using combinatorial logic and memory. The combinatorial logic determines the next state of the state machine, generally based on the current state of the machine and input conditions, to traverse through the sequence of states. Also, the combinatorial logic generates actual outputs, generally based on the current state and sometimes on the input conditions. The memory keeps track of the state.

In the entropy decoding state machine 900, the Boolean ANS decoder 902 and the symbol ANS decoder 904 share a common decoder state 906, but they have separate state evolution functions. That is, the Boolean ANS decoder 902 uses a first function to generate a new ANS state from a current ANS state, while the symbol ANS decoder 904 uses a different, second function to generate a new ANS state from the current ANS state. The decoders 902, 904 of the entropy decoding state machine 900 also have separate inputs into and outputs from a detokenizer 908. The input into the detokenizer 908 from the Boolean ANS decoder 902 is, for example, a single probability (also called a single probability value) when an output from the Boolean ANS decoder 902 is a Boolean value such as the flags and bits described with respect to FIG. 7E. The input into the detokenizer 908 from the symbol ANS decoder 904 is, for example, a probability distribution when an output is a token (also known as a “symbol”) from the symbol ANS decoder 904 such as those described with respect to Table 1 and FIG. 7E. The detokenizer 908 is a single detokenizer in this example, but it is not necessary that the decoder be limited to one detokenizer.

Using the Boolean ANS decoder 902 and the symbol ANS decoder 904 of the entropy decoding state machine 900, and their interaction with the detokenizer 908, the decoding of transform coefficients according to the state diagram 600 can be implemented. More specifically, at the start of the decoding process, the ANS state is initialized to a value within the valid range (e.g., of the EOB node 602), and the buffer position is initialized at a first position within the variable string. The variable string within the buffer 910 is written/read per bitstream data unit (e.g., per byte) in this example.

At each of the Boolean ANS decoder 902 and the symbol ANS decoder 904, three operations occur: state normalization, output computation, and state evolution.

During state normalization, it is determined whether the state is outside of its valid range for the current node. Generally, this means that the state is below the valid range. Because the state is valid at initialization, state normalization is not required for the EOB node 602 at the start of decoding. When state normalization is required, however, it may be achieved in this implementation by reading a single bitstream data unit from the encoded bitstream (e.g., from the buffer 910) and appending it to the low end of the current state 906. When the bitstream data unit is a byte, for example, a single byte is read and is appended to the current state to generate a new state according to (current state<<8)|*byte_ptr--) where <<8 is a left shift of 8 bits, and *byte_ptr-- is the data of the next byte of data (e.g., at a pointer byte_ptr). The buffer position moves within the buffer 910 by the number of bits appended to the current state 906 (eight in this example). If reading a single bitstream data unit is insufficient to bring the state within the valid range for the current node, another bitstream data unit may be appended until the state is within the valid range. Each new bitstream data unit is appended to the new state.

During output computation, the state and the probability or probability distribution from the detokenizer 908 are used to compute an output value (e.g., the decoded transform coefficient value associated with the token). Then, during state evolution, the state, the output value, and the probability or probability distribution are used to calculate the next state to conform to the state diagram 600.

For example, when the state indicates that the entropy decoder state machine 900 is at the EOB node 602, and assuming the state is within range, the Boolean ANS decoder 902 provides the Boolean value of the binary ANS flag to the detokenizer 908, which in turn returns the appropriate context probability. Then, during state evolution, the Boolean value, the state, and the probability are used by the Boolean ANS decoder 902 to compute the next state and relatedly update the buffer position. For example, the next state would be that associated with the ZERO node 604. If state normalization is not required, output computation and state evolution would again occur with the Boolean ANS decoder 902 to read the next binary ANS flag using the appropriate context probability from the detokenizer 908. If state normalization is required because the state is outside the valid range (e.g., for the ZERO node 604), state normalization would occur before the output computation and state evolution at the ZERO node 604.

The symbol ANS decoder 904 operates similarly as it has the same state range property as the Boolean ANS decoder 902 and shares the common decoder state 906, which includes the ANS state (e.g., a scalar or integer) and the buffer position within the memory buffer 910. As mentioned above, it also performs the operations of state normalization, output computation, and state evolution. However, the information exchanged with the detokenizer 908 is different (e.g., input from the detokenization 908 in the form of probability distributions and output to the detokenizer 908 in the form of tokens). Further, the symbol ANS decoder 904 has a separate state evolution operation or function. For example, the symbol ANS decoder 904 does not operate in the state ranges of the EOB node 602 or the ZERO node 604. Instead, the Boolean ANS decoder 902 controls the state evolution (i.e., the common decoder state 906) through the change of state from the ZERO node 604. The symbol ANS decoder 904 controls the state normalization, output computation, and state evolution (and hence, the common decoder state 906) while operating within the range of the TOKEN node 606. The Boolean ANS decoder 902 does not operate in these states.

The entropy decoding state machine 900 thus operates according to the state diagram 600 using the state changes generated by the Boolean ANS decoder 902 and the symbol ANS decoder 904 so as to reconstruct the transform coefficients of an encoded block using the detokenizer 908.

In the entropy encoding state machine 1000, the Boolean ANS encoder 1002 and the symbol ANS encoder 1004 share a common encoder state 1006, but they have separate state evolution functions. That is, the Boolean ANS encoder 1002 uses a first function to generate a new ANS state from a current ANS state, while the symbol ANS encoder 1004 uses a different, second function to generate a new ANS state the current ANS state. Which of the Boolean ANS encoder 1002 or the symbol ANS encoder 1004 controls the state evolution function at any given point depends on the value of the state (i.e., which node of the state diagram encompasses the current state value). The encoders 1002, 1004 of the entropy encoding state machine 1000 also have separate inputs into and outputs from a tokenizer 1008. The output to the tokenizer 1008 from the Boolean ANS encoder 1002 is, for example, a value associated with a flag or bit described with respect to FIG. 7D, while the input to the Boolean ANS encoder 1002 from the tokenizer 1008 is a single probability (also called a single probability value) associated with the flag or bit. The output to the tokenizer 1008 from the symbol ANS encoder 1004 is, for example, a value associated with a token (also known as a “symbol”) such as those described with respect to Table 1 and FIG. 7D, while the input into the symbol ANS encoder 1004 from the tokenizer 1008 is a probability distribution associated with the token. The tokenizer 1008 is a single tokenizer in this example, but more than one may be used.

Using the Boolean ANS encoder 1002 and the symbol ANS encoder 1004 of the entropy encoding state machine 1000, and their interaction with the tokenizer 1008, the encoding of transform coefficients according to the state diagram 800 can be implemented. More specifically, at the start of the encoding process, the ANS state is initialized to a value within the valid range (e.g., of the EOB node 802), and the buffer position is initialized at a first position within the variable string. The variable string within the buffer 1010 is written/read per bitstream data unit (e.g., per byte).

At each of the Boolean ANS encoder 1002 and the symbol ANS encoder 1004, three operations occur: state normalization, output computation, and state evolution.

During state normalization, it is determined whether the state is outside of its valid range. Generally, but not necessarily, this means that the state is above the valid range. Because the state is valid at initialization, state normalization by the Boolean ANS encoder 1002 is not required for the EOB node 802 at the start of encoding. When state normalization is required, however, it may be achieved in this implementation by transferring a single least significant bitstream data unit from the common state 1006 and into the buffer 1010 for inclusion in the encoded bitstream in an operation opposite to that described with respect to the entropy decoding state machine 900. When the bitstream data unit is a byte, for example, a single byte is removed and the current state is used to generate a new state according to (current state>>8) where >>8 is a right shift of 8 bits. The buffer position moves within the buffer 1010 by the number of bits removed from the common encoding state 1006 (eight in this example), which are added to the buffer 1010. If writing a single bitstream data unit is insufficient to bring the state within the valid range for the current node, another bitstream data unit may be removed until the state is within the valid range. Each new bitstream data unit is removed from the new state.

During output computation, the state and the probability or probability distribution from the tokenizer 1008 are used to compute an output value (e.g., the encoded bits for the token). Then, during state evolution, the state, the output value, and the probability or probability distribution are used to calculate the next state to conform to the state diagram 800. Because the operations are similar to those described with respect to the Boolean ANS decoder 902 and the symbol ANS decoder 904, a detailed explanation is omitted. It is sufficient to note that, as with the entropy decoding state machine 900, the range of states of each node of the state diagram does not overlap that of other states, and which of the Boolean ANS encoder 1002 or symbol ANS encoder 1004 controls the state evolution function depends on the value of the state (i.e., which node of the state diagram encompasses the current state value).

The skilled artisan can implement the inventive entropy coders, including the combinations of the Boolean ANS coder and the symbol ANS coder for each of an entropy decoder and entropy encoder, using the description herein. If additional details of ANS encoders and decoders is desired, a further description can be had by reference to Jarek Duda, “Asymmetric numeral systems: entropy coding combining speed of Huffman coding with compression rate of arithmetic coding,” arXiv:1311.2540v2 [cs.IT], 6 Jan. 2014, the entire content of which is incorporated herein in its entirety by reference. For example, Section 3 of Duda discusses an encoding finite-state automaton using ANS and ABS.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of transmitting station 102 and/or receiving station 106 (and the algorithms, methods, instructions, etc., stored thereon and/or executed thereby, including by encoder 400 and decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of transmitting station 102 and receiving station 106 do not necessarily have to be implemented in the same manner.

Further, in one aspect, for example, transmitting station 102 or receiving station 106 can be implemented using a general purpose computer or general purpose processor with a computer program that, when executed, carries out any of the respective methods, algorithms and/or instructions described herein. In addition or alternatively, for example, a special purpose computer/processor can be utilized which can contain other hardware for carrying out any of the methods, algorithms, or instructions described herein.

Transmitting station 102 and receiving station 106 can, for example, be implemented on computers in a video conferencing system. Alternatively, transmitting station 102 can be implemented on a server and receiving station 106 can be implemented on a device separate from the server, such as a hand-held communications device. In this instance, transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by transmitting station 102. Other suitable transmitting station 102 and receiving station 106 implementation schemes are available. For example, receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for decoding an encoded bitstream using a computing device, the encoded bitstream including frames, the frames having blocks of pixels, the method comprising:
receiving the encoded bitstream including encoded transform coefficients of a current block;
initializing a decoder state of an entropy decoder state machine, the entropy decoder state machine including a Boolean asymmetric numeral system (ANS) decoder and a symbol ANS decoder, and the decoder state including an ANS state and a buffer position within a buffer storing a variable string including the encoded transform coefficients;
sequentially producing transform coefficients of the current block from the variable string using the entropy decoder state machine until an end of block flag is reached or a maximum number of transform coefficients is output by:
processing a binary flag or bit using the Boolean ANS decoder to generate an output value for the binary flag or bit using the ANS state; and
processing a token using the symbol ANS decoder to generate an output value for the token using the ANS state;
forming a transform block using the transform coefficients;
inverse transforming the transform block to generate a residual block; and
reconstructing the current block using the residual block.

2. The method of claim 1, further comprising:
the entropy decoder state machine operating according to a single state diagram with five nodes, each of the five nodes encompassing a non-overlapping range of available ANS states; and
after generating the output value, perform a state evolution function for the ANS state, the state evolution function of the Boolean ANS decoder different from a state evolution function of the symbol ANS decoder depending on which of the five nodes in which the entropy decoder state machine is operating.

3. The method of claim 1, further comprising:
sharing a single detokenizer between the Boolean ANS decoder and the symbol ANS decoder, wherein processing the binary flag or bit using the Boolean ANS decoder to generate the output value for the binary flag or bit uses the ANS state and a probability value associated with the flag or bit from the single detokenizer, and processing the token using the symbol ANS decoder to generate the output value for the token using the ANS state and a probability distribution with the token from the single detokenizer.

4. The method of claim 3, wherein:
an output from the single detokenizer to the Boolean ANS decoder is a Boolean value for the binary flag or bit; and
an output from the single detokenizer to the symbol ANS decoder is the token.

5. The method of claim 1, further comprising:
processing the binary flag or bit using the Boolean ANS decoder by:
performing a state normalization operation when the ANS state is outside a valid state range for the binary flag or but by updating the ANS state by appending a bitstream data unit from the variable string, and updating the buffer position;
performing an output computation operation to generate the output value for the binary flag or bit using the ANS state and a probability value associated with the flag or bit; and
performing a state evolution operation to update the ANS state; and
processing the token using the symbol ANS decoder by:
performing a state normalization operation when the ANS state is outside a valid state range for the token by updating the ANS state by appending a bitstream data unit from the variable string, and updating the buffer position;
performing an output computation operation to generate the output value for the token using the ANS state and a probability distribution associated with the token; and
performing a state evolution operation to update the ANS state.

6. The method of claim 5, wherein processing the binary flag or bit using the Boolean ANS decoder comprises performing the state evolution operation to update the ANS state using a first state evolution function, the output value, and the probability value as an input to the first state evolution function, and processing the token using the symbol ANS decoder comprises performing the state evolution operation to update the ANS state using a second state evolution function, the second state evolution function different from the first state evolution function.

7. The method of claim 5, wherein the bitstream data unit is a byte.

8. The method of claim 5, wherein an input/output (I/O) base for ANS decoding is defined by (2U)ⁿ, where n is a positive integer, and U is a size of the bitstream data unit, a probability granularity for the ANS decoding divides evenly into the I/O base, and a base value for the ANS state is evenly divisible by the probability granularity such that all I/O is done in whole bitstream units.

9. An apparatus for decoding an encoded bitstream, the encoded bitstream including frames, the frames having blocks of pixels, the apparatus comprising:
an entropy decoder state machine including a Boolean asymmetric numeral system (ANS) decoder and a symbol ANS decoder sharing an ANS state and sharing a buffer position within a common buffer storing a variable string including encoded tokenized transform coefficients of a current block, the entropy decoder state machine performing a method comprising:
receiving the encoded bitstream including the encoded tokenized transform coefficients of the current block;
decoding the encoded tokenized transform coefficients using the Boolean ANS decoder and the symbol ANS decoder, the Boolean ANS decoder decoding a token comprising a bit or a binary flag and the symbol ANS decoder decoding a token comprising a symbol operating according to a common state diagram comprising multiple nodes encompassing non-overlapping state ranges for the ANS state by:
performing a state normalization operation when the ANS state is outside a valid state range for the token by updating the ANS state by appending a bitstream data unit from the variable string, and updating the buffer position;
performing an output computation operation to generate an output value for the token using the ANS state and a probability associated with the token; and
performing a state evolution operation to update the ANS state using the output value and the probability as inputs, the state evolution operation of the Boolean ANS decoder being different from the state evolution operation of the symbol ANS decoder; and
a processor executing instructions stored in a non-transitory memory to:
form a transform block using decoded transform coefficients corresponding to the tokens;
inverse transform the transform block to generate a residual block; and
reconstruct the current block using the residual block.

10. The apparatus of claim 9, wherein the common state diagram comprises five nodes, a first node that determines whether or not an end of block token has been reached, a second node that determines whether or not an encoded transform coefficient has a value of zero, a third node that outputs a value for a symbol when the encoded transform coefficient does not have a value of zero, a fourth node that decodes extra bits associated with the symbol, when the extra bits are present, and a fifth node that outputs a sign for the encoded transform coefficient when the encoded transform coefficient does not have a value of zero.

11. The apparatus of claim 10, wherein the Boolean ANS decoder performs the state normalization operation, the output computation operation, and the state evolution operation when the entropy decoder state machine is at the first node, the second node, the fourth node, or the fifth node, and wherein the symbol ANS decoder performs the state normalization operation, the output computation operation, and the state evolution operation when the entropy decoder state machine is at the third node.

12. The apparatus of claim 9, wherein the entropy decoder state machine further comprises a single detokenizer coupled to each of the Boolean ANS decoder and the symbol ANS decoder.

13. The apparatus of claim 12, wherein the probability associated with the token is a single probability value from the single detokenizer for the Boolean ANS decoder and the probability associated with the token is a probability distribution from the single detokenizer for the symbol ANS decoder.

14. The apparatus of claim 9, wherein appending the bitstream data unit from the variable string comprises left shifting the ANS state by a number of bits comprising the bitstream data unit, and updating the buffer position comprises moving the buffer position by the number of bits comprising the bitstream data unit removed from the common buffer.

15. An apparatus for encoding a video sequence including frames, the frames having blocks of pixels, the apparatus comprising:
a processor configured to execute instructions stored in a non-transitory memory to:
form a transform block using transform coefficients of a current block; and
tokenize the transform coefficients of the transform block; and
an entropy encoding state machine including a Boolean asymmetric numeral system (ANS) encoder and a symbol ANS encoder sharing an ANS state and sharing a buffer position within a common buffer storing a variable string including encoded tokenized transform coefficients of the current block, the entropy encoder state machine performing a method comprising:
encoding the tokenized transform coefficients using the Boolean ANS encoder and the symbol ANS encoder, the Boolean ANS encoder encoding a token comprising a bit or a binary flag and the symbol ANS encoder encoding a token comprising a symbol operating according to a common state diagram by:
performing a state normalization operation when the ANS state is outside a valid state range for the token by updating the ANS state by removing a bitstream data unit from the ANS state into the variable string, and updating the buffer position;
performing an output computation operation to generate an output value for the token using the ANS state and a probability associated with the token; and
performing a state evolution operation to update the ANS state using the output value and the probability as inputs, the state evolution operation of the Boolean ANS decoding being different from the state evolution operation of the symbol ANS decoder.

16. The apparatus of claim 15, wherein removing the bitstream data unit from the ANS state comprises right shifting the ANS state by a number of bits comprising the bitstream data unit, and updating the buffer position comprises moving the buffer position by the number of bits comprising the bitstream data unit added to the common buffer.

17. The apparatus of claim 16, wherein removing the bitstream data unit from the ANS state comprises removing multiple bitstream data units until the ANS state is within the valid state range for the token.

18. The apparatus of claim 15, wherein the valid state range for the token depends upon a node of the common state diagram in which the entropy encoding state machine is operating.

19. The apparatus of claim 15, wherein the instructions further comprise instructions to form the transform block by:
predicting the current block to form a prediction block;
generate a residual block as a difference between the prediction block and the current block; and
transform the residual block to form the transform block.

20. The apparatus of claim 19, wherein the instructions further comprise instructions to form the transform block by:
quantizing the transform coefficients of the transform block before tokenizing the transform coefficients.
